(19) United States
(12) Patent Application Publication
(10) Pub. No.: US 2025/0226993 A1
(43) Pub. Date: Jul. 10, 2025

(54) System for Encrypted Traffic Analysis and Proxy to Remediate Expired Certificates

(71) Applicant: Cisco Technology, Inc., San Jose, CA (US)

(72) Inventor: Pok Wong, SANTA CLARA, CA (US)

(21) Appl. No.: 18/407,311

(22) Filed: Jan. 8, 2024

(51) Int. Cl. H04L 9/32

(52) U.S. Cl. CPC H04L 9/3268

(57) ABSTRACT

Devices, networks, systems, methods, and processes for traffic analysis are described herein. A device may receive an enhanced NetFlow packet comprising a certificate associated with an Initial Data Packet (IDP) of a data stream. The device can, based on the enhanced NetFlow packet, evaluate whether the certificate has expired. If the certificate has expired, the device can forward the data stream to a proxy. The proxy may issue a proxy certificate, thereby facilitating connection when the certificate has expired. The device may dynamically apply one or more remediation processes upon determining that the certificate has expired. The device can monitor expiration dates of one or more certificates. The device can also provide alerts to an operator or to a network device upon expiry of the one or more certificates.

The present disclosure relates to encrypted digital communication. More particularly, the present disclosure relates to auto-applying remediation for expired certificates in digital communication networks.

### BACKGROUND

Digital communication networks involve communication between multiple interconnected servers and client devices. Usually, the client devices communicate with the servers to access one or more services provided by the servers. To ensure security of information, i.e., data, cryptographic protocols such as Transport Layer Security (TLS) can be utilized. In TLS, certificates are utilized to establish the identity of the servers and client devices. Certificates are primarily employed for authentication, but their usage can vary depending on specific security requirements of the digital communication networks.

Typically, a client device authenticates a server using a certificate. Here, the server presents the certificate, and the client device verifies the certificate to ensure authenticity of the server. Following successful authentication, the client device may log in by utilizing a username and a password. In more robust security approaches, mutual authentication is utilized, where both, the client device and server, present their certificates to establish a two-way trust.

However, the certificates have a limited validity. Typically, the certificates are issued by Certificate Authorities (CAs) which determine the validity of the certificates. When certificates expire, it may lead to service disruption. Usually, when the client devices attempts to connect to the server having the expired certificate, a warning is presented to the client device. This facilitates a user of the client device to inspect the warning and proceed with the connection if desired. However, such user actions are not available in the connection between network devices, such as switches and routers in the digital communication network. As a result, the expiration of the certificates can lead to outages in the digital communication network. The outages can be generally addressed by renewal or replacement of the expired certificates. However, the digital communication network may experience downtime during such renewal or replacement of the expired certificates.

Therefore, there is a need for robust certificate management systems that can monitor expiration dates of the certificates, apply remediation for the expired certificates, and implement proactive certificate management.

### SUMMARY OF THE DISCLOSURE

Systems and methods for auto-applying remediation for expired certificates in digital communication networks in accordance with embodiments of the disclosure are described herein. In some embodiments, a traffic analysis logic is configured to receive an enhanced NetFlow packet including a certificate associated with an Initial Data Packet (IDP), determine an expiration date based on the certificate, evaluate an expiration status of the certificate based on the expiration date, and forward, based on the expiration status, a data stream associated with the IDP to a proxy.

In some embodiments, the expiration status of the certificate is evaluated as expired if the expiration date has elapsed.

In some embodiments, the data stream is forwarded to the proxy if the expiration status of the certificate is evaluated as expired.

In some embodiments, the proxy issues a proxy certificate for the data stream.

In some embodiments, the certificate corresponds to a server or a client device.

In some embodiments, the certificate is indicative of a certificate issuer.

In some embodiments, the traffic analysis logic is further configured to store at least one of the IDP, the certificate, the expiration status, or the expiration date in a table in the memory.

In some embodiments, the table further stores a grace period associated with the certificate.

In some embodiments, the traffic analysis logic is further configured to retrieve the grace period associated with the certificate, and forward the data stream to the proxy if the grace period has elapsed.

In some embodiments, the enhanced NetFlow packet is in a NetFlow template or an Internet Protocol Flow Information Export (IPFIX) template.

In some embodiments, a traffic analysis logic is configured to receive an Initial Data Packet (IDP) including a first certificate, determine a destination Internet Protocol (IP) address associated with the first certificate if the first certificate is encrypted, identify a network device associated with the destination IP address, transmit a connection request to the network device, and receive a second certificate from the network device in response to the connection request.

In some embodiments, a traffic analysis logic is further configured to decrypt the second certificate, and determine an expiration date based on the second certificate.

In some embodiments, the traffic analysis logic is further configured to evaluate an expiration status of the second certificate based on the expiration date, and forward, based on the expiration status, a data stream associated with the IDP to a proxy.

In some embodiments, the expiration status of the second certificate is evaluated as expired if the expiration date has elapsed.

In some embodiments, the data stream is forwarded to the proxy if the expiration status of the second certificate is evaluated as expired.

In some embodiments, the traffic analysis logic is further configured to store at least one of the IDP, the destination IP address, the first certificate, the second certificate, the expiration status, or the expiration date in a table in the memory.

In some embodiments, the table further stores a grace period associated with the second certificate.

In some embodiments, the traffic analysis logic is further configured to retrieve the grace period associated with the second certificate, and forward the data stream to the proxy if the grace period has elapsed.

In some embodiments, an enhanced NetFlow packet including a certificate associated with Initial Data Packet (IDP) is received, an expiration date based on the certificate is determined, an expiration status of the certificate based on the expiration date is evaluated, and based on the expiration status, a data stream associated with the IDP is forwarded to a proxy.

In some embodiments, a method, further including retrieving a grace period associated with the certificate, and forwarding the data stream to the proxy if the grace period has elapsed.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of establishment of a connection between a client device and a server, in accordance with various embodiments of the disclosure;

FIG. 2 is a conceptual illustration of a communication network, in accordance with various embodiments of the disclosure;

FIG. 3 is a conceptual illustration of a communication network, in accordance with various embodiments of the disclosure;

FIG. 4 is a conceptual network diagram of various environments that a traffic analyzer may operate on a plurality of network devices, in accordance with various embodiments of the disclosure;

FIG. 5 is a flowchart depicting a process for forwarding a data stream, in accordance with various embodiments of the disclosure;

FIG. 6 is a flowchart depicting a process for proxying a data stream in a grace period, in accordance with various embodiments of the disclosure;

FIG. 7 is a flowchart depicting a process for auto-remediating expired encrypted certificates, in accordance with various embodiments of the disclosure; and

FIG. 8 is a conceptual block diagram of a device suitable for configuration with a traffic analysis logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that analyze data traffic between devices in a communication network. In many embodiments, the communication network may include multiple client devices and servers. Each client device and server can possess a certificate. The certificate may be utilized to establish connection between the client device and the server. In that, the client device and the server can exchange corresponding certificates by implementing a Transport Layer Security (TLS) handshake. In some embodiments, while utilizing TLS 1.2 or earlier protocols, after establishing the connection, the client device or the server may begin transmitting an encrypted data stream. In certain embodiments, while utilizing TLS 1.3, the exchange of the certificates between the client device and the server can also be encrypted. The communication network may further include a network controller coupled with a flow analyzer. In more embodiments, the network controller and the flow analyzer can be implemented in a single device. A network device, such as a router or a switch, may function as a flow monitor or collector by collecting intra-flow metadata, such as Encrypted Traffic Analytics (ETA) data corresponding to the data stream exchanged between the devices in the communication network. The network device may capture a first data packet, i.e., Initial Data Packet (IDP) of the data stream. The network device can extract information of the first data packet. The network device may share the IDP data with the flow analyzer in form of an enhanced NetFlow packet in a NetFlow template or an Internet Protocol Flow Information Export (IPFIX) template. In some more embodiments, the network device may utilize a modified NetFlow template or a modified IPFIX template.

In a number of embodiments, for example, the NetFlow template may include multiple key fields and non-key fields, such as, but not limited to, source Internet Protocol (IP) address, destination IP address, source and destination transport ports, and protocol information. In some embodiments, for example in TLS 1.3, the modified NetFlow template may include one or more additional fields, such as, but not limited to, fields related to information about server certificate, client certificate, TLS version, certificate validity, certificate expiration date etc. That is, in certain embodiments, the network device may utilize the modified NetFlow template to record the server certificate and/or certificate metadata that may include information about the server certificate. In more embodiments, the network device may only capture and analyze the first data packet of the data stream. In some more embodiments, for example, the first data packet may correspond to a “server hello” or a “client hello” message.

In various embodiments, the flow analyzer can determine an expiration date of the certificate based on the enhanced NetFlow packet. The expiration date may be assigned by a Certificate Authority (CA). The flow analyzer can also determine if the certificate is self-signed or locally issued. The flow analyzer may also determine a certificate issuer of the certificate. The certificate issuer may be utilized by the network controller to select one or more remediation processes. The flow analyzer can determine an expiration status of the certificate based on the expiration date. The expiration status of the certificate may be determined as “expired” if the expiration date has elapsed. The expiration status of the certificate can be determined as “not expired” if the expiration date is in future. If the expiration status of the certificate is expired, the network controller may select and apply one or more remediation processes. In that, the network controller can store one or more predefined remediation processes. The network controller may select an appropriate remediation process from the one or more predefined remediation processes based on at least one of: the certificate, the certificate metadata, or the certificate issuer etc., for example. In some embodiments, for example, the network controller can configure a network device, such as a router or a switch, to apply the selected remediation process. In certain embodiments, the network controller may configure the network device to forward the data stream to a proxy. When the certificate has expired, the proxy may issue a proxy certificate to maintain the connection between the server and the client device. In more embodiments, the proxy may be dynamically enabled when the expiration status of the certificate is determined to be expired. The network controller can further monitor expiration dates of one or more certificates. The network controller may also provide alerts to an operator or to a network device when the upon expiry of the one or more certificates.

In additional embodiments, the flow analyzer can be further configured to store a table. The table may store the IDP, the certificate, the certificate metadata, the expiration status, and the expiration date. The table can also store a grace period corresponding to the certificates. When the certificate has expired, the grace period may be utilized to decide whether the data stream can be forwarded to the proxy. Upon determining that the certificate has expired, the network controller may look up the grace period in the table. The network controller can determine whether the grace period has expired or not. If the grace period has not expired, the network controller may configure the network device, such as the router or the switch, to forward the data stream to the proxy. Thereafter, the proxy may facilitate the connection between the client device and the server by providing the proxy certificate. The network controller can further monitor grace periods associated with the one or more certificates. The network controller may also provide alerts to the operator or to the network device when the upon expiry of the one or more grace periods.

In further embodiments, the client device and the server may utilize more secure protocols such as, but not limited to, TLS 1.3 for secured communication. In such protocols, the certificate in the “server hello” message may be encrypted. Therefore, the network device may determine the destination IP address from the IDP corresponding to the “client hello” message. The network device can utilize the destination IP address to identify the server that corresponds to the destination IP address. The network device may initiate a new connection with the identified server. The new connection may include a TLS handshake. During the initiation of the new connection, the network device may obtain a second certificate from the server. The network device can transmit the second certificate to the flow analyzer in form of the enhanced NetFlow packet. Thereafter, the flow analyzer may store the second certificate and the certificate metadata corresponding to the second certificate in the table. The flow analyzer can determine the expiration date based on the second certificate. The flow analyzer may determine the expiration status of the second certificate. Thereafter, if the second certificate has expired, the network controller may forward the data stream to the proxy. In some embodiments, the network controller may look up the grace period corresponding to the second certificate. The network controller can thereafter forward the data stream to the proxy if the grace period corresponding to the second certificate has not expired.

Advantageously, the traffic analyzer of the present disclosure may prevent service disruptions, outages, and downtime of the communication network caused by the expiration of the certificates by auto-applying remediation processes for the expired certificates. Since the network controller can configure the network devices to dynamically proxy the data stream, the traffic analyzer of the present disclosure may work efficiently with the network devices in existing communication networks, without requiring hardware changes to the network devices or topological changes to the communication network. Further, the traffic analyzer may capture and analyze the first data packet, without requiring capturing or analyzing subsequent data packets, thereby simplifying processing and ensuring faster processing.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

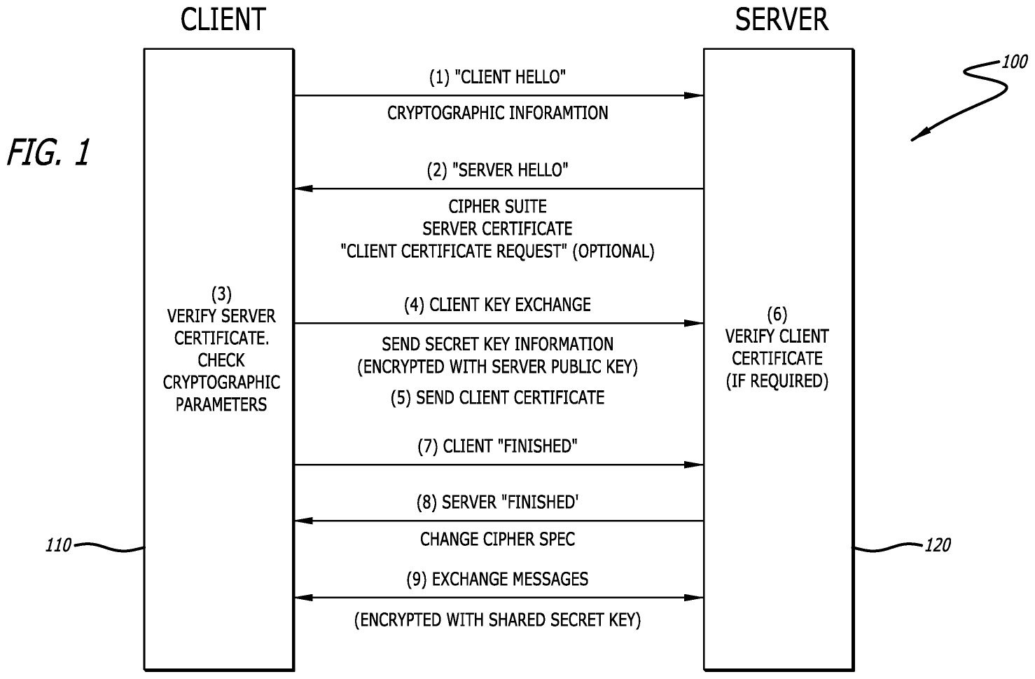

Referring to FIG. 1, a conceptual illustration of a connection between a client device 110 and a server 120, in accordance with various embodiments of the disclosure is shown. In many embodiments, a “client hello” message may be sent by the client device 110 to the server 120 for initiating the connection (step 1). In some embodiments, the “client hello” message can include fields such as, supported Transport Layer Security (TLS) versions, cipher suites supported by the client device 110, key data etc., for example. In certain embodiments, the exchange of cipher suites in the “client hello” message may facilitate the client device 110 and the server 120 to establish initial parameters for establishing a secure connection. In more embodiments, if the client device 110 attempts to resume a previous session, the “client hello” message may also include a session identifier (Session ID) of the previous session.

In a number of embodiments, the server 120 may respond to the “client hello” message by a transmitting a “server hello” message (step 2). In some embodiments, the “server hello message” can include fields such as, the Session ID, the cipher suite selected by the server 120, the TLS version selected by the server 120, for example. In certain embodiments, the server 120 may select a highest TLS version supported by the client device 110. In more embodiments, the “server hello” message can include a server certificate corresponding to the server 120. In some more embodiments, optionally, the server 120 may request for a client certificate to authenticate the client device 110.

Thereafter, in various embodiments, the client device 110 can verify the server certificate (step 3). In some embodiments, the client device 110 may determine an issuer of the server certificate. In certain embodiments, the client device 110 can determine if the server certificate is signed by a Certificate Authority (CA) or an intermediate CA. In more embodiments, if the certificate is signed by one or more intermediate CAs, the client device 110 may verify entire chain of certificates associated with the server certificates. In some more embodiments, the client device 110 can check for validity of the server certificate, i.e., expiration status of the server certificate, revocation status of the server certificate, etc. In numerous embodiments, the client device 110 may check for one or more cryptographic parameters associated with the server certificate.

In additional embodiments, the client device 110 can exchange keys with the server 120 (step 4). In some embodiments, the client device 110 may transmit secret key information encrypted by a server public key. In certain embodiments, the key exchange can be implemented by may methods, such as, but not limited to, Rivest-Shamir-Adleman (RSA) keys.

In further embodiments, the client device may transmit the client certificate (step 5). In some embodiments, if the server 120 had requested the client certificate, the client device 110 may send the client certificate. In certain embodiments, for more secure connections that require two-way trust, the server 120 may request the client device 110 to share the client certificate. In more embodiments, the client certificate, similar to the server certificate, can be associated with a public key and a corresponding private key. In some more embodiments, the public key may be shared with the server 120 and the private key may be stored in the client device 110.

Thereafter, in many more embodiments, the server 120 may verify the client certificate (step 6). In some embodiments, similar to verification of the server certificate by the client device 110, the server 120 can verify the client certificate by checking expiration status of the client certificate, revocation status of the client certificate, signatures of the CAs, etc. In certain embodiments, the server 120 may alert the client device 110 if the client certificate has expired.

In many additional embodiments, the client device 110 and the server 120 may exchange “client finished” and “server finished” messages (step 7 and step 8). In some embodiments, the “client finished” and “server finished” messages can be indicative of completion of the TLS handshake. In certain embodiments, after completing the TLS handshake, the client device 110 and the server 120 can exchange encrypted messages, i.e., the encrypted data stream (step 9). In more embodiments, the messages may be encrypted by utilizing a shared secret key.

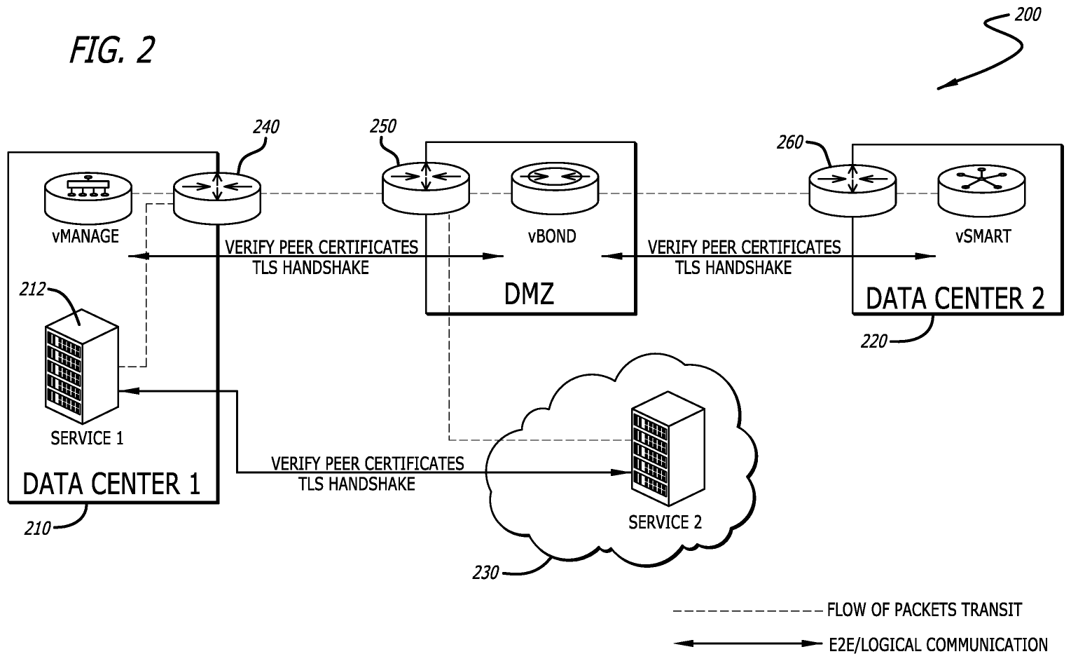

Although a specific embodiment for the connection between the client device 110 and the server 120 for carrying out the various steps, processes, methods, and operations described herein is discussed with respect to FIG. 1, any of a variety of systems and/or processes may be utilized in accordance with embodiments of the disclosure. For example, the connection may be established between one or more network devices, such as, but not limited to, routers and switches in a communication network. The elements depicted in FIG. 1 may also be interchangeable with other elements of FIGS. 2-8 as required to realize a particularly desired embodiment.

Referring to FIG. 2, a conceptual illustration of a communication network 200, in accordance with various embodiments of the disclosure is shown. In many embodiments, the communication network 200 may include a first data center 210 including a first server 212, a second data center 220, and a second server 230. The first data center 210, the second data center 220, and the second server 230 may be interconnected by way of wired and/or wireless connections. The communication network 200 may further include a first router 240 associated with the first data center 210, a second router 250 associated with a Demarcation Zone or Demilitarized Zone (DMZ) and the second server 230, and a third router 260 associated with the second data center 220. The first router 240, the second router 250, and the third router 260 may facilitate establishment of connections between the first data center 210, the second data center 220, and the second server 230.

In various embodiments, as shown in FIG. 2, multiple network devices, such as the first data center 210 and the second data center 220 in the communication network 200, can authenticate or mutually authenticate each other. These network devices may include one or more services. For instance, as shown in FIG. 2, the first data center 210 can be associated with a first service and the second data center 220 can be associated with a second service. The services may include software components running on a Virtual Machine (VM) or device hardware. Examples of the first server 212 and the second server 230 may include, but are not limited to, Software-Defined Wide Area Network (SDWAN) VM servers, or web servers. The first data center 210 and the second data center 220 may communicate via an underlying network routing and switching infrastructure including the first router 240, the second router 250, and the third router 260. The first router 240, the second router 250, and the third router 260 may mutually authenticate each other by utilizing non-expired certificates.

Although a specific embodiment for the communication network 200 for carrying out the various steps, processes, methods, and operations described herein is discussed with respect to FIG. 2, any of a variety of systems and/or processes may be utilized in accordance with embodiments of the disclosure. For example, communication network 200 may facilitate encrypted data transmission between various devices by utilizing TLS protocol. The elements depicted in FIG. 2 may also be interchangeable with other elements of FIG. 1 and FIGS. 3-8 as required to realize a particularly desired embodiment.

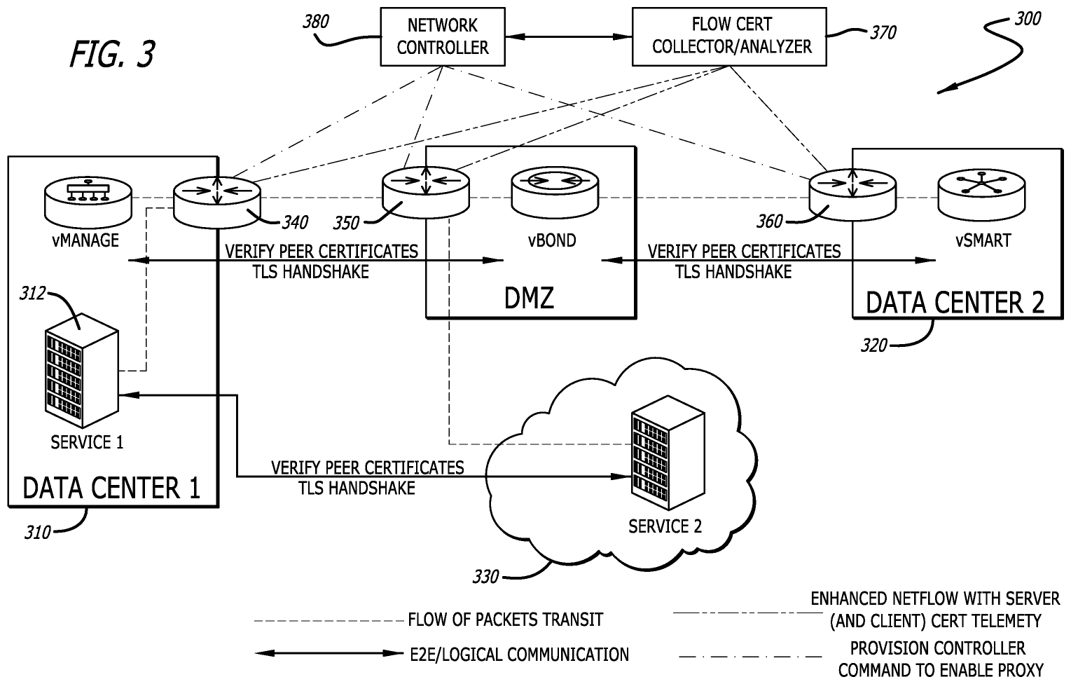

Referring to FIG. 3, a conceptual illustration of a communication network 300, in accordance with various embodiments of the disclosure is shown. In many embodiments, the communication network 300 may include a first data center 310 including a first server 312, a second data center 320, and a second server 330. The first data center 310, the second data center 320, and the second server 330 may be interconnected by way of wired and/or wireless connections. The communication network 300 may further include a first router 340 associated with the first data center 310, a second router 350 associated with a DMZ and the second server 330, and a third router 360 associated with the second data center 320. The first router 340, the second router 350, and the third router 360 may facilitate establishment of connections between the first data center 310, the second data center 320, and the second server 330.

In a number of embodiments, the communication network 300 may further include a flow analyzer 370 and a network controller 380. In some embodiments, the flow analyzer 370 and the network controller 380 can be implemented in a single device. The flow analyzer 370 can receive, analyze, and store intra-flow metadata, such as Encrypted Traffic Analytics (ETA) data corresponding to data exchanged between the devices in the communication network 300. In certain embodiments, one or more of: the first router 340, the second router 350, or the third router 360 may capture a first data packet, i.e., Initial Data Packet (IDP) of a data stream. The first router 340, the second router 350, or the third router 360 can extract information of the first data packet, i.e., IDP data and generate an enhanced NetFlow packet. The first router 340, the second router 350, or the third router 360 may share the enhanced NetFlow packet with the flow analyzer 370 in form of a NetFlow template or an Internet Protocol Flow Information Export (IPFIX) template. In some more embodiments, the first router 340, the second router 350, or the third router 360 may utilize a modified NetFlow template or a modified IPFIX template. The modified NetFlow template may comprise a field for a certificate, i.e., the first router 340, the second router 350, or the third router 360 may share the certificate with the flow analyzer 370 in form of the enhanced NetFlow packet.

In various embodiments, the first router 340, the second router 350, or the third router 360 may only capture and analyze the first data packet of the data stream. In some more embodiments, for example, the first data packet may correspond to the “server hello” or the “client hello” message. In some embodiments, the flow analyzer 370 can determine an expiration date of the certificate based on the enhanced NetFlow packet. The flow analyzer 370 can determine an expiration status of the certificate based on the expiration date. If the expiration status of the certificate is expired, the network controller 380 may select and apply one or more remediation processes. The network controller can configure a network device, such as one of the routers: the first router 340, the second router 350, or the third router 360 to apply the selected remediation process. In that, the network controller 380 may configure the network device to forward the data stream to a proxy.

Although a specific embodiment for the communication network 300 for carrying out the various steps, processes, methods, and operations described herein is discussed with respect to FIG. 3, any of a variety of systems and/or processes may be utilized in accordance with embodiments of the disclosure. For example, the network controller 380 may dynamically enable the proxy when the expiration status of the certificate is determined to be expired. The elements depicted in FIG. 3 may also be interchangeable with other elements of FIGS. 1-2 and FIGS. 4-8 as required to realize a particularly desired embodiment.

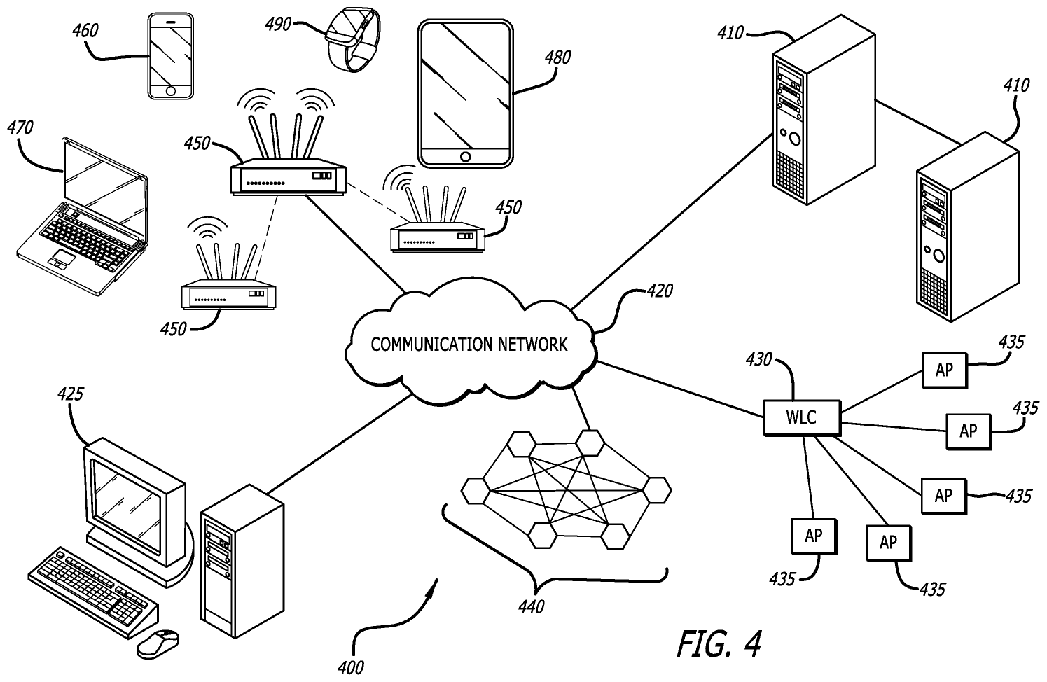

Referring to FIG. 4, a conceptual network diagram 400 of various environments that a traffic analyzer may operate on a plurality of network devices, in accordance with various embodiments of the disclosure is shown. Those skilled in the art will recognize that the traffic analyzer can be comprised of various hardware and/or software deployments and can be configured in a variety of ways. In many embodiments, the traffic analyzer can be configured as a standalone device, exist as a logic in another network device, be distributed among various network devices operating in tandem, or remotely operated as part of a cloud-based network management tool. In further embodiments, one or more servers 410 can be configured with or otherwise operate the traffic analyzer. In many embodiments, the traffic analyzer may operate on one or more servers 410 connected to a communication network 420. The communication network 420 can include wired networks or wireless networks. In many embodiments, the communication network 420 may be a Wi-Fi network operating on various frequency bands, such as, 2.4 GHz, 5 GHz, or 6 GHz. In further embodiments, the traffic analyzer operating on the servers 410 can analyze data traffic shared in the network 400. The traffic analyzer can be provided as a cloud-based service that can service remote networks, such as, but not limited to a deployed network 440. In many embodiments, the traffic analyzer can be a logic that detects if certificates of one or more network devices are expired.

However, in additional embodiments, the traffic analyzer may be operated as a distributed logic across multiple network devices. In the embodiment depicted in FIG. 4, a plurality of APs 450 can operate as the traffic analyzer in a distributed manner or may have one specific device operate as the traffic analyzer for all of the neighboring or sibling APs 450. The APs 450 facilitate Wi-Fi connections for various electronic devices, such as but not limited to mobile computing devices including laptop computers 470, cellular phones 460, portable tablet computers 480 and wearable computing devices 490.

In further embodiments, the traffic analyzer may be integrated within another network device. In the embodiment depicted in FIG. 4, a wireless LAN controller (WLC) 430 may have an integrated traffic analyzer that the WLC 430 can use to analyze the data traffic within the various APs 435 that the WLC 430 is connected to, either wired or wirelessly. In still more embodiments, a personal computer 425 may be utilized to access and/or manage various aspects of the traffic analyzer, either remotely or within the network itself. In the embodiment depicted in FIG. 4, the personal computer 425 communicates over the communication network 420 and can access the traffic analyzer of the servers 410, or the network APs 450, or the WLC 430.

Although a specific embodiment for various environments that the traffic analyzer may operate on a plurality of network devices suitable for carrying out the various steps, processes, methods, and operations described herein is discussed with respect to FIG. 4, any of a variety of systems and/or processes may be utilized in accordance with embodiments of the disclosure. In many non-limiting examples, the traffic analyzer may be provided as a device or software separate from the network devices or the traffic analyzer may be integrated into the network devices. The elements depicted in FIG. 4 may also be interchangeable with other elements of FIGS. 1-3 and 5-8 as required to realize a particularly desired embodiment.

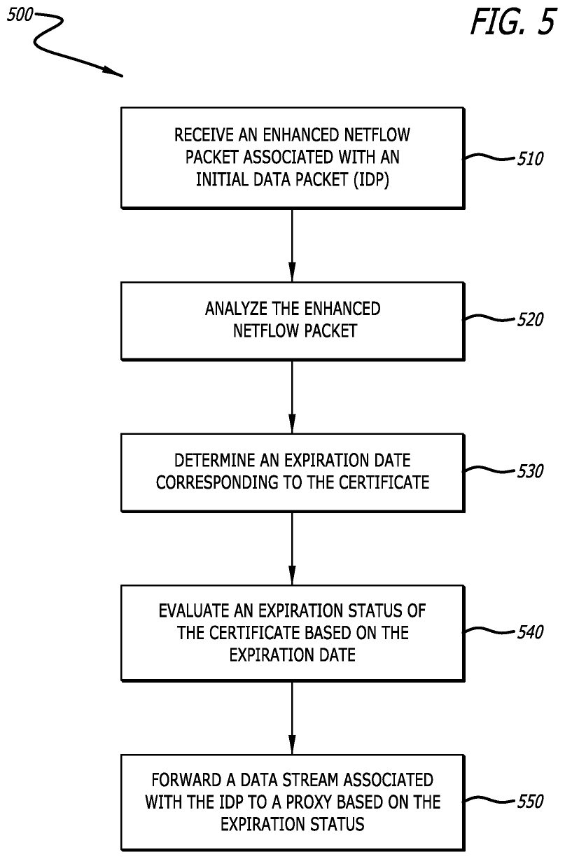

Referring to FIG. 5, a flowchart depicting a process 500 for forwarding the data stream, in accordance with various embodiments of the disclosure is shown. In many embodiments, the process 500 may receive the enhanced NetFlow packet comprising the certificate associated with the IDP (block 510). In some embodiments, the process 500 can be implemented by the flow analyzer, the network controller, or jointly by the flow analyzer and the network controller. In more embodiments, the enhanced NetFlow packet can be in form of a NetFlow template or an IPFIX template. In numerous embodiments, the first data packet may correspond to the “server hello” message or the “client hello” message. In many further embodiments, the enhanced NetFlow packet can include the server certificate or the client certificate.

In a number of embodiments, the process 500 can analyze the enhanced NetFlow packet (block 520). In some embodiments, the NetFlow template may include multiple key fields and non-key fields, such as, but not limited to, source IP address, destination IP address, source and destination transport ports, and protocol information. In certain embodiments, for example in TLS 1.3, the enhanced or modified NetFlow template may further include one or more additional fields, such as, but not limited to, fields related to information about the server certificate or the client certificate, TLS version, certificate validity, certificate expiration date etc. That is, in more embodiments, the process 500 may utilize the enhanced NetFlow packet to record the certificate and/or certificate metadata that may include information about the certificate.

In various embodiments, the process 500 may determine an expiration date based on the enhanced NetFlow packet (block 530). In some embodiments, the expiration date may be assigned by the CA. In certain embodiments, the process 500 can also determine if the certificate is self-signed or locally issued. In more embodiments, the process 500 may also determine the certificate issuer of the certificate. In some more embodiments, the certificate issuer may be utilized by the network controller to select one or more remediation processes.

In additional embodiments, the process 500 can evaluate the expiration status of the certificate based on the expiration date (block 540). In some embodiments, the expiration status of the certificate may be determined as “expired” if the expiration date has elapsed. In certain embodiments, the expiration status of the certificate can be determined as “not expired” if the expiration date is in future.

In further embodiments, the process 500 may forward the data stream associated with the IDP to the proxy based on the expiration status (block 550). In some embodiments, if the expiration status of the certificate is expired, the process 500 may select and apply one or more remediation processes. In certain embodiments, the network controller can store one or more predefined remediation processes. In more embodiments, the process 500 may select an appropriate remediation process from the one or more predefined remediation processes based on at least one of: the certificate, the certificate metadata, or the certificate issuer etc., for example. In some more embodiments, for example, the process 500 can configure the network device, such as the router or the switch, to apply the selected remediation process. In numerous embodiments, the process 500 may configure the network device to forward the data stream to the proxy. In many further embodiments, when the certificate has expired, the proxy may issue the proxy certificate to maintain the connection between the server and the client device.

Although a specific embodiment for the process 500 for forwarding the data stream for carrying out the various steps, processes, methods, and operations described herein is discussed with respect to FIG. 5, any of a variety of systems and/or processes may be utilized in accordance with embodiments of the disclosure. For example, the process 500 may dynamically enable the proxy when the expiration status of the certificate is determined to be expired. The elements depicted in FIG. 5 may also be interchangeable with other elements of FIGS. 1-4 and FIGS. 6-8 as required to realize a particularly desired embodiment.

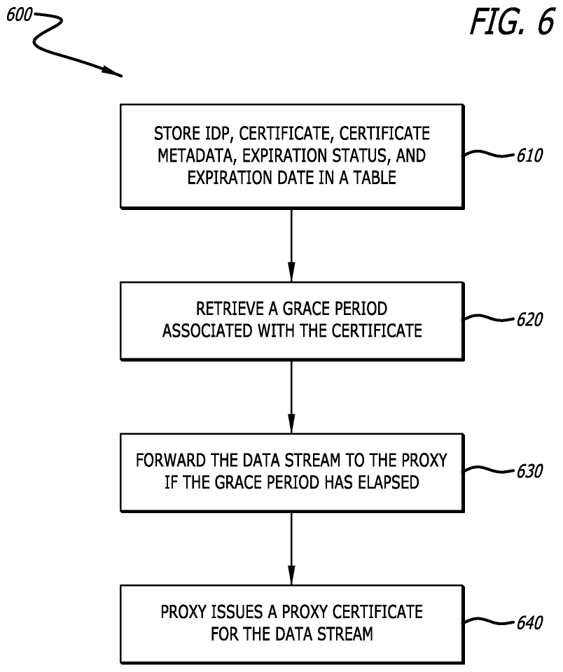

Referring to FIG. 6, a flowchart depicting a process 600 for proxying the data stream in the grace period, in accordance with various embodiments of the disclosure is shown. In many embodiments, the process 600 can store the enhanced NetFlow packet, the certificate, the certificate metadata, the expiration status, and the expiration date in a table (block 610). In some embodiments, the process 600 may be implemented by the network controller. In certain embodiments, the table may further store the grace period associated with each certificate. In more embodiments, when the certificate has expired, the grace period may be utilized to decide whether the data stream can be forwarded to the proxy.

In a number of embodiments, the process 600 may retrieve the grace period associated with the certificate (block 620). In some embodiments, when the process 600 determines that the certificate has expired, the process 600 may check if the grace period associated with the certificate has expired. In certain embodiments, the process 600 can dynamically enable the proxy without checking the grace period if the service is a critical service or the server is an internal server in the communication network.

In various embodiments, the process 600 can forward the data stream to the proxy if the grace period has elapsed (block 630). In some embodiments, if the grace period has not expired, the process 600 may configure the network device, such as the router or the switch, to forward the data stream to the proxy. In certain embodiments, the process 600 can provide the alert to the operator after determining that the grace period has expired.

In additional embodiments, the process 600 may facilitate the connection through the proxy (block 640). In some embodiments, the proxy can issue the proxy certificate for the data stream. In certain embodiments, the client device may establish the connection with the server based on the proxy certificate.

Although a specific embodiment for the process 600 for proxying the data stream in the grace period for carrying out the various steps, processes, methods, and operations described herein is discussed with respect to FIG. 6, any of a variety of systems and/or processes may be utilized in accordance with embodiments of the disclosure. For example, the process 600 may dynamically enable the proxy when the grace period associated with the certificate is determined to be expired. The elements depicted in FIG. 6 may also be interchangeable with other elements of FIGS. 1-5 and FIGS. 7-8 as required to realize a particularly desired embodiment.

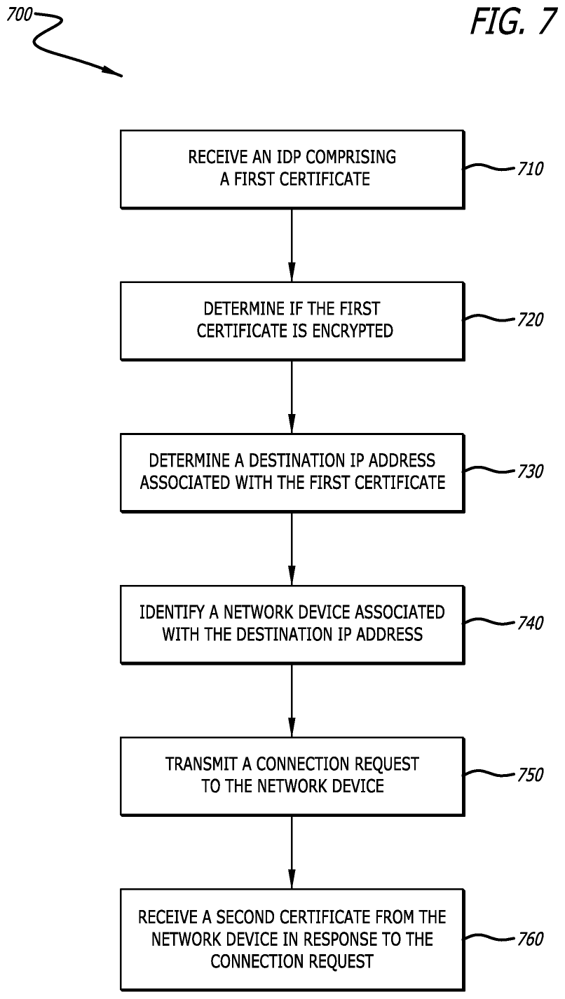

Referring to FIG. 7, a flowchart depicting a process 700 for auto-remediating expired encrypted certificates, in accordance with various embodiments of the disclosure is shown. In many embodiments, the process 700 can receive an IDP comprising a first certificate (block 710). In some embodiments, the IDP may correspond to the first data packet. In certain embodiments, the first data packet can correspond to the “server hello” message that includes the server certificate. In certain embodiments, the process 700 may be implemented by the network device, such as the router or the switch that receives the data stream from the client device or the server.

In a number of embodiments, the process 700 may determine if the first certificate is encrypted (block 720). In some embodiments, the client device and the server may utilize protocols such as TLS 1.3 for secured communication. In certain embodiments, in such protocols, the certificate associated with the first data packet can be encrypted.

In various embodiments, the process 700 can determine the destination IP address associated with the first certificate (block 730). In some embodiments, the “client hello” message in TLS 1.3 may not be encrypted. Therefore, in certain embodiments, the process 700 can determine the destination IP address based on the destination IP address in the “client hello” message.

In additional embodiments, the process 700 may identify the network device associated with the destination IP address (block 740). In some embodiments, the network device may be the server that the client device attempts to connect. In certain embodiments, the network device can be within the communication network.

In further embodiments, the process 700 can transmit a new connection request to the network device (block 750). In some embodiments, the server certificate may be decrypted only by the client device that sends a connection request. In certain embodiments, the process 700 may transmit the new connection request to the server for receiving the cryptographic keys of the server. In more embodiments, the process 700 can initiate the TLS handshake with the server.

In many more embodiments, the process 700 may receive a second certificate from the network device in response to the new connection request (block 760). In some embodiments, the process 700 implemented by the router or the switch may generate and transmit the enhanced NetFlow packet comprising the second certificate to the flow analyzer. In some embodiments, the flow analyzer can decrypt the second certificate. Thereafter, in certain embodiments, the flow analyzer may store the second certificate and/or the certificate metadata corresponding to the second certificate in the table. In more embodiments, the flow analyzer can determine the expiration date based on the second certificate. In some more embodiments, the flow analyzer may determine the expiration status of the second certificate based on the expiration date. Thereafter, in numerous embodiments, if the second certificate has expired, the process 700 may forward the data stream to the proxy.

Although a specific embodiment for the process 700 for auto-remediating expired encrypted certificates for carrying out the various steps, processes, methods, and operations described herein is discussed with respect to FIG. 7, any of a variety of systems and/or processes may be utilized in accordance with embodiments of the disclosure. For example, the process 700 may select and apply remediation processes in protocols such as TLS 1.3 where the server certificate is encrypted. The elements depicted in FIG. 7 may also be interchangeable with other elements of FIGS. 1-6 and FIG. 8 as required to realize a particularly desired embodiment.

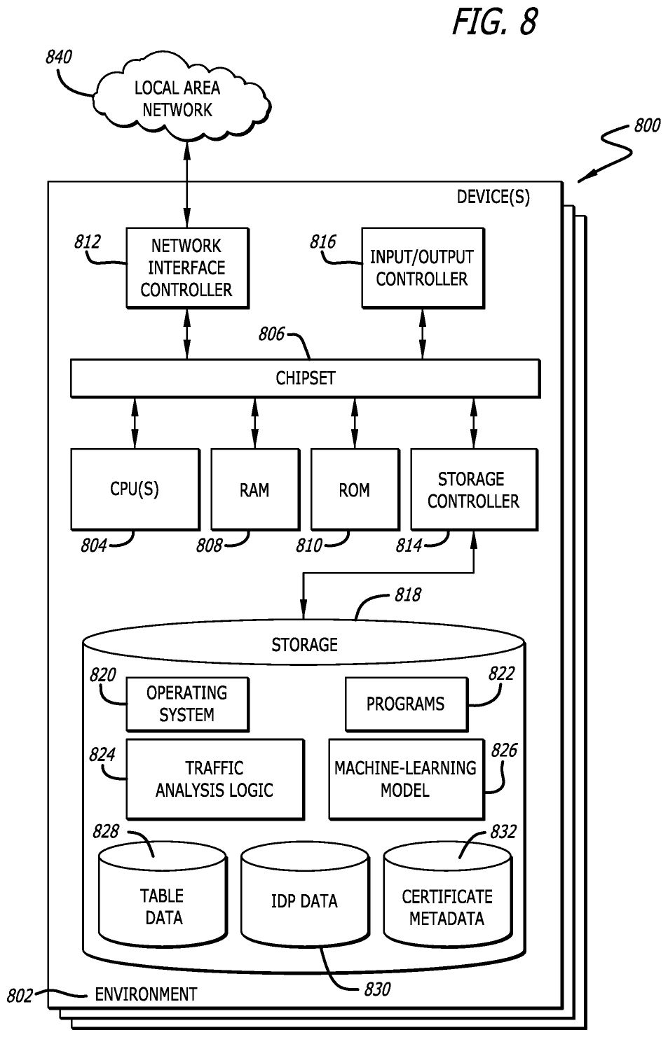

Referring to FIG. 8, a conceptual block diagram of a device 800 suitable for configuration with a traffic analysis logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, table data 828, IDP data 830, and certificate metadata 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The table data 828 can store the IDP, the certificate, the certificate metadata, the expiration status, and the expiration date. The IDP data 830 may be in the NetFlow template or the IPFIX template. The IDP data 830 can store multiple key fields and non-key fields, such as, but not limited to, source IP address, destination IP address, source and destination transport ports, and protocol information. The certificate metadata 832 may be utilized to store one or more additional fields of the IDP data 830, such as, but not limited to, fields related to information about server certificate, client certificate, TLS version, certificate validity, certificate expiration date etc.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a traffic analysis logic 824. The traffic analysis logic 824 can be configured to perform one or more of the various steps, processes, operations, and/or other methods that are described above. Often, the traffic analysis logic 824 can be a set of instructions stored within a non-volatile memory that, when executed by the processor(s)/controller(s) 804 can carry out these steps, etc. In some embodiments, the traffic analysis logic 824 may be a client application that resides on a network-connected device, such as, but not limited to, a server, switch, personal or mobile computing device in a single or distributed arrangement. The traffic analysis logic 824 can analyze the data traffic in the communication network and proxy the data traffic via the proxy when the one or more certificates are expired.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the table data 828, the IDP data 830, and the certificate metadata 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for the device 800 suitable for configuration with the traffic analysis logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a traffic analysis logic, configured to:
receive an enhanced NetFlow packet comprising a certificate associated with an Initial Data Packet (IDP);
determine an expiration date based on the certificate;
evaluate an expiration status of the certificate based on the expiration date; and
forward, based on the expiration status, a data stream associated with the IDP to a proxy.

2. The device of claim 1, wherein the expiration status of the certificate is evaluated as expired if the expiration date has elapsed.

3. The device of claim 2, wherein the data stream is forwarded to the proxy if the expiration status of the certificate is evaluated as expired.

4. The device of claim 1, wherein the proxy issues a proxy certificate for the data stream.

5. The device of claim 1, wherein the certificate corresponds to a server or a client device.

6. The device of claim 1, wherein the certificate is indicative of a certificate issuer.

7. The device of claim 1, wherein the traffic analysis logic is further configured to store at least one of: the IDP, the certificate, the expiration status, or the expiration date in a table in the memory.

8. The device of claim 7, wherein the table further stores a grace period associated with the certificate.

9. The device of claim 8, wherein the traffic analysis logic is further configured to:
retrieve the grace period associated with the certificate; and
forward the data stream to the proxy if the grace period has elapsed.

10. The device of claim 1, wherein the enhanced NetFlow packet is in a NetFlow template or an Internet Protocol Flow Information Export (IPFIX) template.

11. A device, comprising:
a processor;
a memory communicatively coupled to the processor; and
a traffic analysis logic, configured to:
receive an Initial Data Packet (IDP) comprising a first certificate;
determine a destination Internet Protocol (IP) address associated with the first certificate if the first certificate is encrypted;
identify a network device associated with the destination IP address;
transmit a connection request to the network device; and
receive a second certificate from the network device in response to the connection request.

12. The device of claim 11, wherein the traffic analysis logic is further configured to:
decrypt the second certificate; and
determine an expiration date based on the second certificate.

13. The device of claim 12, wherein the traffic analysis logic is further configured to:
evaluate an expiration status of the second certificate based on the expiration date; and
forward, based on the expiration status, a data stream associated with the IDP to a proxy.

14. The device of claim 13, wherein the expiration status of the second certificate is evaluated as expired if the expiration date has elapsed.

15. The device of claim 14, wherein the data stream is forwarded to the proxy if the expiration status of the second certificate is evaluated as expired.

16. The device of claim 15, wherein the traffic analysis logic is further configured to store at least one of: the IDP, the destination IP address, the first certificate, the second certificate, the expiration status, or the expiration date in a table in the memory.

17. The device of claim 16, wherein the table further stores a grace period associated with the second certificate.

18. The device of claim 17, wherein the traffic analysis logic is further configured to:
retrieve the grace period associated with the second certificate; and
forward the data stream to the proxy if the grace period has elapsed.

19. A method, comprising:
receiving an enhanced NetFlow packet comprising a certificate associated with Initial Data Packet (IDP);
determining an expiration date based on the certificate;
evaluating an expiration status of the certificate based on the expiration date; and
forwarding, based on the expiration status, a data stream associated with the IDP to a proxy.

20. The method of claim 19, further comprising:
retrieving a grace period associated with the certificate; and
forwarding the data stream to the proxy if the grace period has elapsed.
